(19) United States
(12) Patent Application Publication
(10) Pub. No.: US 2025/0119873 A1
(43) Pub. Date: Apr. 10, 2025

(54) WIRELESS COMMUNICATION DEVICE AND SECOND WIRELESS COMMUNICATION DEVICE

(71) Applicant: FUJITSU LIMITED, Kawasaki-shi Kanagawa (JP)

(72) Inventors: Yoshiaki OHTA, Yokohama (JP); YOSHIHIRO KAWASAKI, Kawasaki (JP); Tetsuya YANO, Yokohama (JP); Takako HORI, Sagamihara (JP)

(73) Assignee: FUJITSU LIMITED, Kawasaki-shi (JP)

(21) Appl. No.: 18/971,121

(22) Filed: Dec. 6, 2024

Related U.S. Application Data
(63) Continuation of application No. PCT/JP2022/023466, filed on Jun. 10, 2022.

(51) Int. Cl. H04W 68/02; H04W 36/08; H04W 76/19; H04W 76/20

(52) U.S. Cl. CPC H04W 68/02; H04W 36/08; H04W 76/19; H04W 76/20

(57) ABSTRACT

A wireless communication apparatus includes, a communicator configured to perform a first type data communication which transmits and receives first type data with a counter wireless communication apparatus in a first mode, and processor circuitry configured to control to perform the first type data communication by controlling to transmit, to the counter wireless communication apparatus in the first mode, a second paging for performing the first type data communication via a plurality of specific cells in an area which is formed by a plurality of cells, the area being transmitted a first paging, the second paging being different from a first paging.

### CROSS-REFERENCE TO RELATED APPLICATION

This application is a continuation application of International Application PCT/JP2022/023466 filed on Jun. 10, 2022 and designated the U.S., the entire contents of which are incorporated herein by reference.

### FIELD

The present disclosure relates to a wireless communication device and a second wireless communication device.

### BACKGROUND

In connection to a base station device, a plurality of states are defined for a terminal device in a wireless communication system. For example, the terminal device has an RRC_INACTIVE state (temporarily suspended state) or the like in addition to an RRC_CONNECTED state (communicating state) and an RRC_IDLE state (disconnected state).

In the RRC_INACTIVE state, the terminal device turns OFF a wireless unit to achieve power saving. In the RRC_INACTIVE state, the terminal device turns ON the wireless unit at timing of, e.g., receiving paging (e.g., RAN Paging) to receive the paging. The paging is a message that calls the terminal device. In addition, by performing Measurement when turning ON the wireless unit for receiving the paging, the terminal device aggregates timing at which the wireless unit is turned ON and reduce power consumed by turning ON/OFF the wireless unit.

When mobility occurs in the RRC_INACTIVE state, the terminal device performs, e.g., cell reselection. The cell reselection is processing of, e.g., measuring a signal in a cell other than a cell (serving cell) in which the terminal device is camped on and moving to a more appropriate cell.

Technologies related to the cell reselection of the terminal device are described in the following related art literatures.

### CITATION LIST

### Patent Literature

Japanese National Publication of International Patent Application No.2021-514576
Japanese National Publication of International Patent Application No.2020-503800
International Publication Pamphlet No. WO 2019/029110
International Publication Pamphlet No. WO 2018/145661

### Non-Patent Literature

Non-patent literature 1: 3GPP (registered trademark) TS36.133 LTE-A Radio Measurement Specification V17.5.0
Non-patent literature 2: 3GPP TS36.300 LTE-A Overview Specification V17.0.0
Non-patent literature 3: 3GPP TS36.211 LTE-A PHY Channel Specification V17.1.0
Non-patent literature 4: 3GPP TS36.212 LTE-A PHY Encoding Specification V17.1.0
Non-patent literature 5: 3GPP TS36.213 LTE-A PHY Procedure Specification V17.1.0
Non-patent literature 6: 3GPP TS36.214 LTE-A PHY Measurement Specification V17.0.0
Non-patent literature 7: 3GPP TS36.321 LTE-A MAC Specification V17.0.0
Non-patent literature 8: 3GPP TS36.322 LTE-A RLC Specification V17.0.0
Non-patent literature 9: 3GPP TS36.323 LTE-A PDCP Specification V17.0.0
Non-patent literature 10: 3GPP TS36.331 LTE-A RRC Specification V17.0.0
Non-patent literature 11: 3GPP TS36.413 LTE-A S1 Specification V17.0.0
Non-patent literature 12: 3GPP TS36.423 LTE-A X2 Specification V17.0.0
Non-patent literature 13: 3GPP TS36.425 LTE-A Xn Specification V17.0.0
Non-patent literature 14: 3GPP TR36.912 NR Radio Access Overview V17.0.0
Non-patent literature 15: 3GPP TR38.913 NR Requirements V17.0.0
Non-patent literature 16: 3GPP TR38.801 NR Network Architecture Overview V14.0.0
Non-patent literature 17: 3GPP TR38.802 NR PHY Overview V14.2.0
Non-patent literature 18: 3GPP TR38.803 NR RF Overview V14.3.0
Non-patent literature 19: 3GPP TR38.804 NR L2 Overview 14.0.0
Non-patent literature 20: 3GPP TR38.900 NR High Frequency Overview V15.0.0
Non-patent literature 21: 3GPP TS38.300 NR Overview Specification V17.0.0
Non-patent literature 22: 3GPP TS37.340 NR Multiple Access Overview Specification V17.0.0
Non-patent literature 23: 3GPP TS38.201 NR PHY Specification Overview Specification V17.0.0
Non-patent literature 24: 3GPP TS38.202 NR PHY Service Overview Specification V17.1.0
Non-patent literature 25: 3GPP TS38.211 NR PHY Channel Specification V17.1.0
Non-patent literature 26: 3GPP TS38.212 NR PHY Encoding Specification V17.1.0
Non-patent literature 27: 3GPP TS38.213 NR PHY Data Channel Procedure Specification V17.1.0
Non-patent literature 28: 3GPP TS38.214 NR PHY Control Channel Procedure Specification V17.1.0
Non-patent literature 29: 3GPP TS38.215 NR PHY Measurement Specification V17.1.0
Non-patent literature 30: 3GPP TS38.321 NR MAC Specification V17.0.0
Non-patent literature 31: 3GPP TS38.322 NR RLC Specification V17.0.0
Non-patent literature 32: 3GPP TS38.323 NR PDCP Specification V17.0.0
Non-patent literature 33: 3GPP TS37.324 NR SDAP Specification V17.0.0
Non-patent literature 34: 3GPP TS38.331 NR RRC Specification V17.0.0
Non-patent literature 35: 3GPP TS38.401 NR Architecture Overview Specification V17.0.0
Non-patent literature 36: 3GPP TS38.410 NR Core Network Overview Specification V17.0.0
Non-patent literature 37: 3GPP TS38.413 NR Core Network AP Specification V17.0.0
Non-patent literature 38: 3GPP TS38.420 NR Xn Interface Overview Specification V17.0.0
Non-patent literature 39: 3GPP TS38.423 NR XnAP Specification V17.0.0
Non-patent literature 40: 3GPP TS38.470 NR F1 Interface Overview Specification V17.0.0
Non-patent literature 41: 3GPP TS38.473 NR F1AP Specification V17.0.0

In the RRC_INACTIVE state, the terminal device may perform transmission/reception of small data (Small Data Transmission: SDT) with the base station device. When mobility occurs during communication by the SDT and the terminal device performs the cell reselection, a phenomenon such that the small data cannot be transmitted/received or the transmission/reception thereof takes time may occur, and service based on the SDT may not be able to be continued.

### SUMMARY

According to an aspect of the embodiments, a wireless communication apparatus includes, a communicator configured to perform a first type data communication which transmits and receives first type data with a counter wireless communication apparatus in a first mode, and a processor configured to control to perform the first type data communication by controlling to transmit, to the counter wireless communication apparatus in the first mode, a second paging for performing the first type data communication via a plurality of specific cells in an area which is formed by a plurality of cells, the area being transmitted a first paging, the second paging being different from a first paging.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a figure illustrating an example of wireless communication in a wireless communication system 1.

FIG. 2 is a figure illustrating an example of a configuration of a wireless communication system 10.

FIG. 3 is a figure illustrating an example of a configuration of the terminal device 100.

FIG. 4 is a figure illustrating an example of a configuration of the base station device 200.

FIG. 5 is a figure illustrating an example of a sequence in a first method.

FIG. 6 is a figure illustrating an example of a sequence of downlink data transmission in a Cell Update method.

FIG. 7 is a figure illustrating an example of a sequence of uplink data transmission in the Cell Update method.

FIG. 8 is a figure illustrating an example of the transmission opportunity for the Cell Update.

FIG. 9 is a figure illustrating an example of selection criteria for selecting a new cell in the cell reselection.

FIG. 10 is a figure illustrating an example of a timer value of the SDT Failure Timer.

FIG. 11 is a figure illustrating an example of an RLC maximum number of retransmissions.

FIG. 12 is a figure illustrating an example of ResumeCause.

FIG. 13 is a figure illustrating an example of a SDT sequence in the UE-specific RNA.

FIG. 14 is a figure illustrating an example of the SDT sequence in the UE-specific RNA.

FIG. 15 is a figure illustrating an example of the ResumeCause.

### DESCRIPTION OF EMBODIMENTS

### First Embodiment

A wireless communication system 1 includes wireless communication devices 3-1 and 3-2 and a counter wireless communication device 2. The wireless communication devices 3-1 and 3-2 and the counter wireless communication device 2 are wirelessly connected to each other to wirelessly transmit/receive data. The wireless communication devices 3-1 and 3-2 and the counter wireless communication device 2 deal with first-type data communication for transmitting/receiving first-type data in a first mode.

The wireless communication devices 3-1 and 3-2 and the counter wireless communication device 2 have respective processors. The processors perform programs stored in the wireless communication devices 3-1 and 3-2 and the counter wireless communication device 2 to build control units 5-1 and 5-2 and a second control unit 4. Processing performed by the wireless communication devices 3-1 and 3-2, which will be described below, may also be interpreted as being performed by the control units 5-1 and 5-2. Processing performed by the counter wireless communication device 2, which will be described below, may also be interpreted as being performed by the second control unit 4.

The first mode is a mode in which the transmission/reception of the first-type data can be performed with predetermined timing. For example, in the first mode, the counter wireless communication device 2 turns ON a wireless unit at predetermined timing to provide a state where a signal (message or channel) can be received.

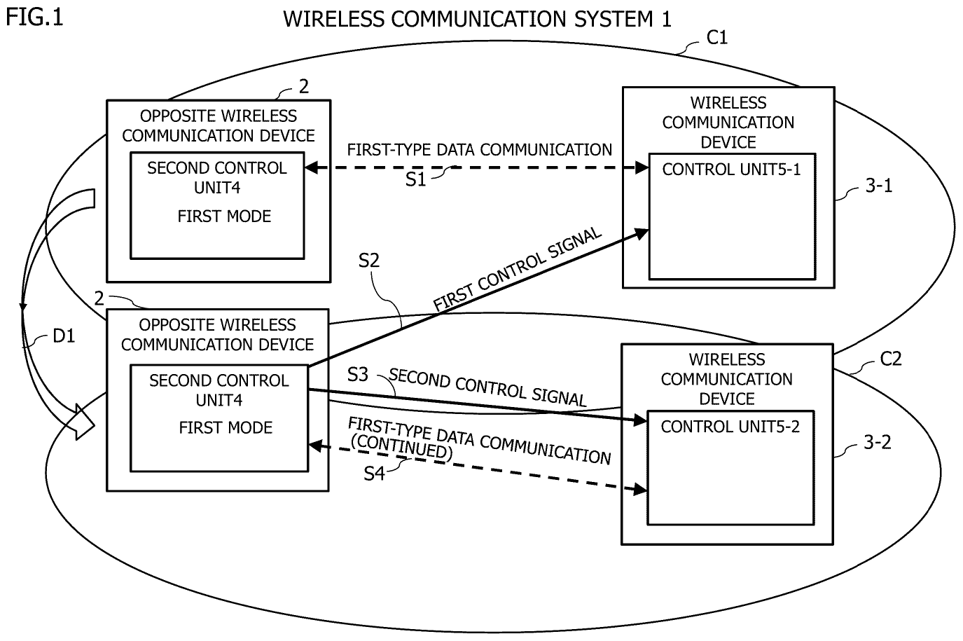

FIG. 1 is a diagram illustrating an example of communication control over the first-type data communication in the wireless communication system 1. The wireless communication devices 3-1 and 3-2 can perform communication control for continuing the first-type data communication. The wireless communication device 3-1 has a communication area C1 representing a communicable range. Meanwhile, the wireless communication device 3-2 has a communication area C2 representing a communicable range. Hereinafter, the communication area C1 may be referred to also as the first communication range C1, while the communication area C2 may be referred to also as the second communication range C2.

The counter wireless communication device 2 is in the first mode and camped on the first communication range C1 to perform the first-type data communication with the wireless communication device 3-1 (S1).

For example, the counter wireless communication device 2 moves in a direction of an arrow D1. The counter wireless communication device 2 searches a new communication area with given timing. Then, the counter wireless terminal device 2 determines that a cell in which communication is to be performed hereinafter is changed (moved) from the first communication range C1 to the second communication range C2.

When changing the communication range, the counter wireless communication device 2 transmits a first control signal to the wireless communication device 3-1 in the first communication range C1 (S2). When receiving the first control signal (S2), the wireless communication device 3-1 stops, e.g., data transmission/reception in the first-type data communication.

When changing the communication range, the counter wireless communication device 2 transmits a second control signal to the wireless communication device 3-2 in the second communication range C2 (S3). When receiving the second control signal (S3), the wireless communication device 3-2 identifies the counter wireless communication device 2 (recognizes movement of the counter wireless communication device 2 to the second communication range C2), and performs the first-type data communication in the second communication range C2 (S4). Thus, the wireless communication device 3-2 can continue the first-type data communication in the second communication range C2.

Note that, when a wireless communication device has a plurality of communication ranges, the wireless communication devices 3-1 and 3-2 may also be a single wireless communication device.

### Second Embodiment

A description will be given below of a second embodiment.

### Wireless Communication System 10

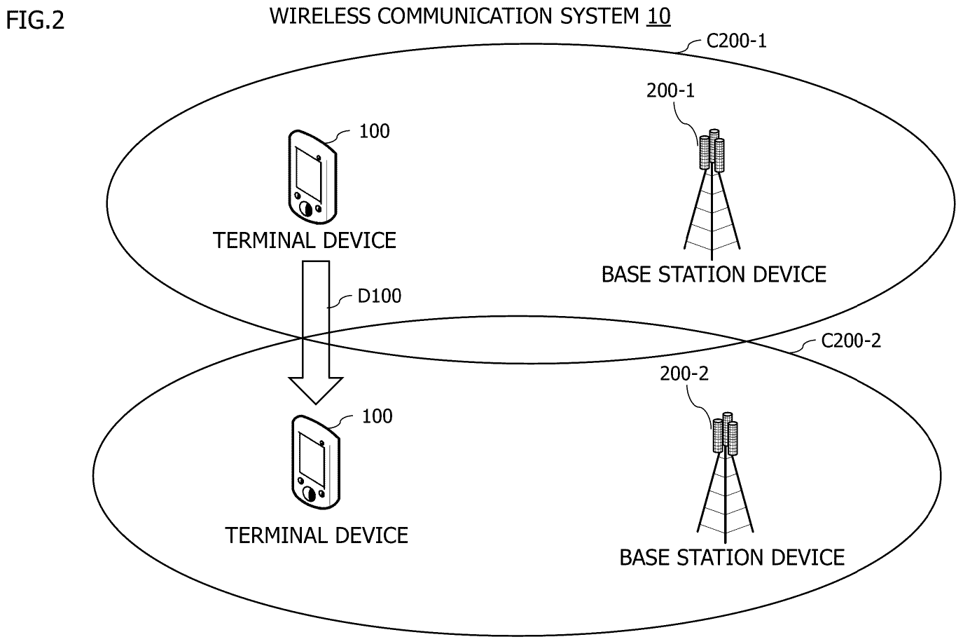

FIG. 2 is a diagram illustrating an example of a structure of a wireless communication system 10. The wireless communication system 10 includes base station devices 200-1 and 200-2 and a terminal device 100. For example, the wireless communication system 10 is a wireless communication system dealing with uplink and downlink SDT in an RRC_INACTIVE state. It is assumed that small data indicates, e.g., data of a predetermined size or less. It is also assumed that the predetermined size indicates a size transmittable in the following method (e.g., size according to a size of a channel, a size of a wireless frame, or the like).

The terminal device 100 is a communication device wirelessly connected to the base station device 200-1 or 200-2 to perform data transmission/reception, which is, e.g., a smartphone or a table terminal. In FIG. 2, the terminal device 100 is one, but a plurality of the terminal devices 100 may also be present.

Each of the base station devices 200-1 and 200-2 (which may be hereinafter referred to also as a base station device 200) deals with, e.g., various communication generations (such as, e.g., 5G and Beyond 5G). The base station device 200 may be configured to include one unit or may also be configured to include a plurality of units such as a CU (Central Unit), a DU (Distributed Unit), and an RU (Radio Unit).

The base station devices 200-1 and 200-2 have respective communication areas (cells) C200-1 and C200-2. For example, a communication area is a range in which wireless communication with the terminal device 100 is possible.

The terminal device 100 is wirelessly connected to the base station device 200-1 to perform wireless communication W101. Then, the terminal device 100 ends communication, performs a predetermined sequence, and transfers to the RRC_INACTIVE state.

For example, the terminal device 100 moves in a direction of an arrow D100. Then, the terminal device 100 receives a signal in a cell (cell C200-2) other than a serving cell (cell C200-1), and measures a radio wave condition. When a measurement result satisfies a predetermined condition, the terminal device 100 performs cell reselection on a cell subjected to the measurement.

Note that, in the following description, unless otherwise particularly specified, the terminal device 100 performs the cell reselection from the base station device 200-1 to the base station device 200-2. In addition, when the base station device 200 is configured to include the plurality of DUs and RUs and have a plurality of cells, the terminal device 100 may also perform the cell reselection to a different cell in the same base station device 200. When the cell reselection is to be performed to a different cell in the same base station device 200, the base station device 200-1 (pre-movement base station device) and the base station device 200-2 (post-movement base station device) in the subsequent sequence may also be read respectively as a pre-movement cell and a post-movement cell.

### Example of Structure of Terminal Device 100

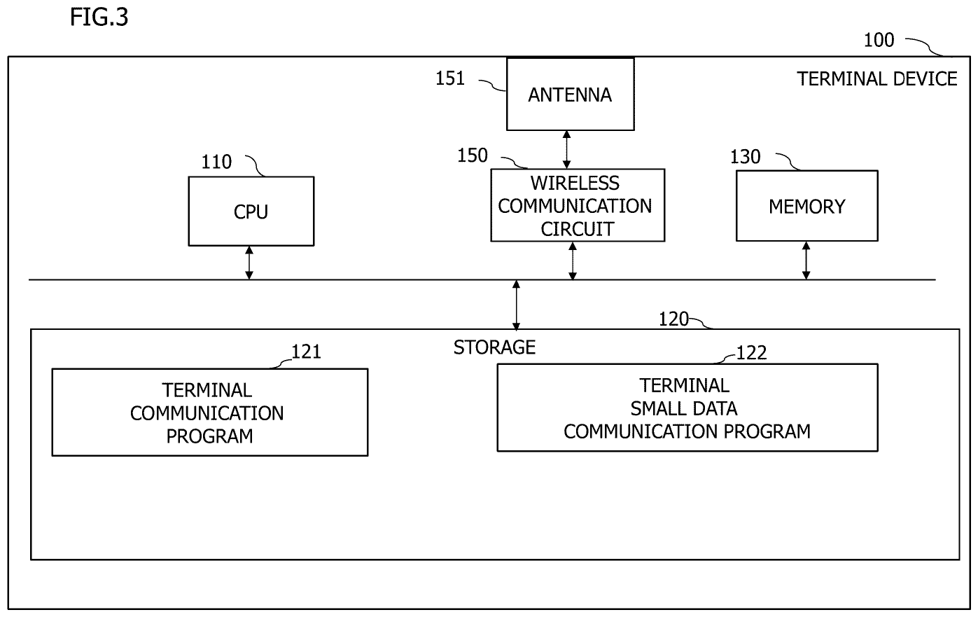

FIG. 3 is a diagram illustrating an example of a structure of the terminal device 100. The terminal device 100 includes a CPU (Central Processing Unit) 110, a storage 120, a memory 130, a wireless communication circuit 150, and an antenna 151.

The storage 120 is an auxiliary storage device that stores a program and data, such as a flash memory, an HDD (Hard Disk Drive), or an SSD (Solid State Drive). The storage 120 stores a terminal communication program 121 and a terminal-side small data communication program 122.

The memory 130 is a region into which the programs stored in the storage 120 are to be loaded. The memory 130 may also be used as a region in which a program stores data.

The wireless communication circuit 150 is a device that performs wireless communication with the base station device 200 and the other terminal device 100. The wireless communication circuit 150 incudes the antenna 151. For example, the antenna 151 includes a directional antenna that can control a direction of transmission/reception of a radio wave.

The CPU 110 is a processor that loads the programs stored in the storage 120 into the memory 130 and executes the loaded programs to build each of the units and implement each processing.

The CPU 110 executes the terminal communication program 121 to build a second communication unit and perform terminal communication processing. The terminal communication processing is processing of being wirelessly connected to the base station device 200 and the other terminal device 100 to perform wireless communication.

The CPU 110 executes the terminal-side small data communication program 122 to build a second control unit and perform terminal-side small data communication processing. The terminal-side small data communication processing is processing of controlling transmission/reception of the small data between the terminal device 100 in the RRC_INACTIVE state and the base station device 200 in the terminal device 100.

### Example of Structure of Base Station Device 200

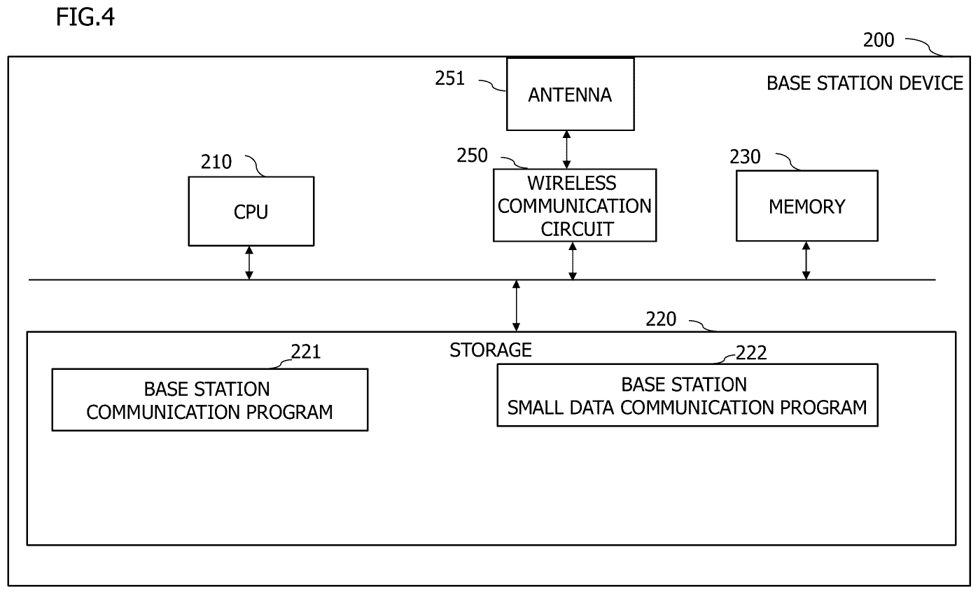

FIG. 4 is a diagram illustrating an example of a structure of the base station device 200. The base station device 200 includes a CPU 210, a storage 220, a memory 230, a wireless communication circuit 250, and an antenna 251.

The storage 220 is an auxiliary storage device that stores a program and data, such as a flash memory, a HDD, or an SSD. The storage 220 stores a base station communication program 221 and a base-station-side small data communication program 222.

The memory 230 is a region into which the programs stored in the storage 220 are to be loaded. The memory 230 may also be used as a region in which a program stores data.

The wireless communication circuit 250 is a device that performs wireless communication with the terminal device 100. The wireless communication circuit 250 includes the antenna 251. For example, the antenna 251 includes a directional antenna capable of controlling a direction of transmission/reception of a radio wave.

The CPU 210 is a processor that loads the programs stored in the storage 220 into the memory 230 and executes the loaded programs to build each of the units and implement each processing.

The CPU 210 executes the base station communication program 221 to build a communication unit and perform communication processing. The base station communication processing is processing of performing wireless communication with the terminal device 100. In the base station communication processing, the base station device 200 is wirelessly connected to the terminal device 100 to transmit data and a control signal to the terminal device 100 and receive data from the terminal device 100.

The CPU 210 executes the base-station-side small data communication program 222 to build a control unit and perform base-station-side small data communication processing. The base-station-side small data communication processing is processing of controlling the transmission/reception of the small data between the terminal device 100 in the RRC_INACTIVE state and the base station device 200 in the base station device 200.

### SDT During Cell Reselection

The following will describe an example of a processing method when the cell reselection is to be performed during the SDT or when the small data is generated. Note that data in the following description indicates the small data unless otherwise particularly specified.

### 1. First Method

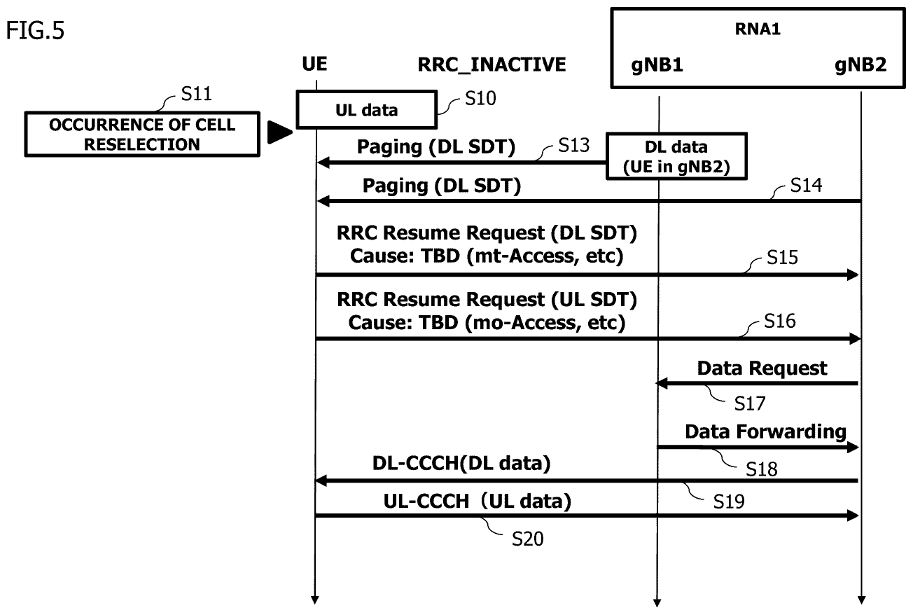

FIG. 5 is a diagram illustrating an example of a sequence in a first method. The first method is a method in which uplink and downlink SDT is performed after waiting for timing to transmit the paging to the terminal device 100.

In FIG. 5, the base station devices 200-1 (gNB1) and 200-2 (gNB2) belong to RNA1, which is the same RNA (RAN Notification Area). Meanwhile, the terminal device 100 is in the RRC_INACTIVE state. It is assumed that, in the subsequent drawings also, the respective states of the RNA to which the base station devices 200-1 and 200-2 belong and the terminal device 100 are the same as those in FIG. 5.

In the terminal device 100 (UE), uplink data is generated (S10). Then, before transmission of the uplink data, the terminal device 100 performs the cell reselection (S11).

Meanwhile, in the base station device 200-1, downlink data is generated (S12). At this timing, the terminal device 100 is camped on a cell of the base station device 200-2 in the cell reselection.

To transmit the downlink data to the terminal device 100, each of the base station devices 200-1 and 200-2 transmits the paging (RAN paging) (S13 and S14). Note that, since the RAN paging occurs with respect to the entire RNA, the paging is consequently transmitted from both of the base station devices 200-1 and 200-2 belonging to the same RNA.

The terminal device 100 receives the paging from the base station device 200-2, and transmits RRC Resume Request for downlink data transmission to the base station device 200-2 (S15).

In addition, the terminal device 100 receives the paging from the base station device 200-2, and transmits the RRC Resume Request including the uplink data to the base station device 200-2 (S16).

When receiving the RRC Resume Request for downlink data transmission, the base station device 200-2 transmits a data request (Data Request) to the base station device 200-1 before movement due to the cell reselection (S17). When receiving the data request, the base station device 200-1 causes a data response (Data Forwarding) to include the untransmitted downlink data and transmits the data response to the base station device 200-2 (S18).

The base station device 200-2 causes DL-CCCH to include the downlink data and transmits the DL-CCCH to the terminal device 100 (S19). The terminal device 100 causes UL-CCCH to include the uplink data (or ACK) and transmits the UL-CCCH to the base station device 200-2.

The DL-CCCH is an example of a message (channel) for, e.g., transmitting the small data to the terminal device 100 in the RRC_INACTIVE state. Meanwhile, the UL-CCCH is an example of a message (channel) for transmitting the small data from the terminal device 100 in the RRC_INACTIVE state. The UL-CCCH is, e.g., the RRC Resume Request. In the subsequent drawings, unless otherwise particularly specified, the same applies to the DL-CCCH and the UL-CCCH.

### 2. Cell Update Method

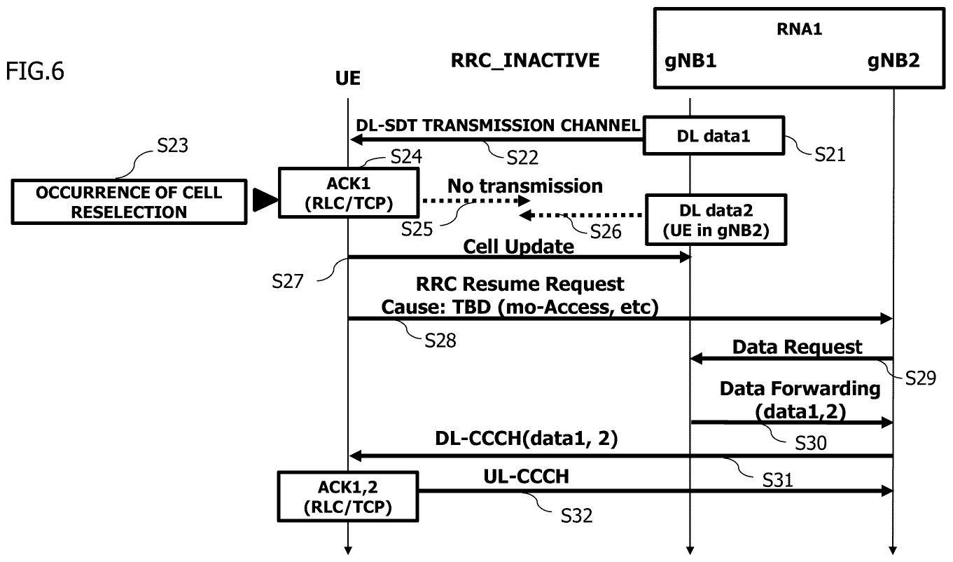

FIG. 6 is a diagram illustrating an example of a sequence of downlink data transmission in a Cell Update method. The Cell Update method is a method in which a procedure equivalent to Cell Update is performed on the terminal device 100 that is performing or is about to perform the SDT. Parameters (related information) of the Cell Update method are set by, e.g., an RRC message when the SDT is set.

In the base station device 200-1, downlink data 1 occurs (S21). The base station device 200-1 causes a channel (e.g., the DL-CCCH, the same applies hereinbelow) for small data transmission to include the downlink data 1 and transmits the channel for small data transmission to the terminal device 100 (S22).

The terminal device 100 receives the downlink data 1 (S22), and attempts to transmit ACK1 for confirming receipt of the downlink data 1 (S24). However, the cell reselection occurs (S23), and the terminal device 100 fails in transmitting (or does not transmit) the ACK1 (S25).

Meanwhile, the base station device 200-1 fails in transmitting downlink data 2 occurred after the cell reselection (S26).

The terminal device 100 transmits the Cell Update to the base station device 200-1 (S27). When receiving the Cell Update, the base station device 200-1 recognizes that the terminal device 100 has performed the cell reselection (identifies the terminal device 100), and stops the SDT to the terminal device 100. When receiving the Cell Update, even when, e.g., there is accumulated data (including the ACK) that has not been completely transmitted (which is untransmitted or for which the transmitted ACK is not received), the base station device 200-1 does not transmit the accumulated data to the terminal device 100.

Meanwhile, to transmit the ACK1 to the base station device 200-2, the terminal device 100 transmits the RRC Resume Request to the base station device 200-2 (S28).

When receiving the RRC Resume Request, the base station device 200-2 transmits a data request to the base station device 200-1 before the movement due to the cell reselection (S29). When receiving the data request, the base station device 200-1 causes a data response to include the downlink data 1 and 2 and transmits the data response to the base station device 200-2 (S30). Note that, since the base station device 200-1 has not received the ACK1 in response to the downlink data 1 and recognizes that the downlink data 1 is also in an untransmitted state, both of the downlink data 1 and 2 become data to be transmitted.

The base station device 200-2 causes the DL-CCCH to include the downlink data 1 and 2 and transmits the DL-CCCH to the terminal device 100 (S31). The terminal device 100 causes the UL-CCCH to include the ACK1 and ACK2 indicating the reception of the downlink data 2, and transmits the UL-CCCH to the base station device 200-2 (S32).

Note that, when the cell reselection is performed to a different cell in the same base station device 200, the data request and the data response may also be omitted.

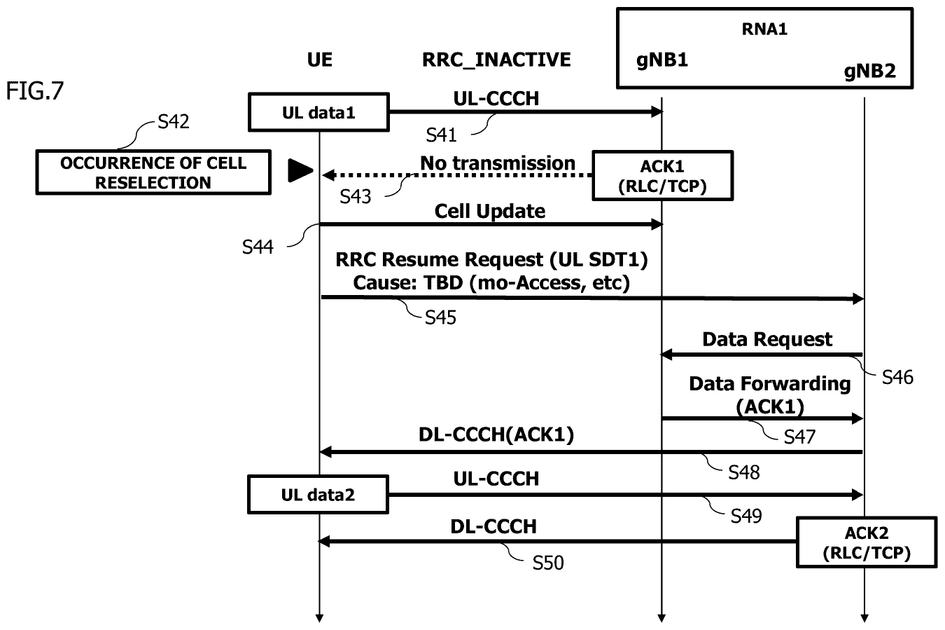

FIG. 7 is a diagram illustrating an example of a sequence of uplink data transmission in the Cell Update method. The terminal device 100 causes the UL-CCCH to include uplink data 1 and transmits the UL-CCCH to the base station device 200-1 (S41). Then, the terminal device 100 performs the cell reselection (S42).

The base station device 200-1 receives the uplink data 1 (S41), and attempts to transmit the ACK1 indicating the reception of the uplink data 1 to the terminal device 100, but fails in transmission since it is after the cell reselection (S43).

The terminal device 100 transmits the Cell Update to the base station device 200-1 (S44). Consequently, communication between the terminal device 100 and the base station device 200-1 is temporarily interrupted.

Meanwhile, to receive the ACK1 from the base station device 200-2, the terminal device 100 transmits the RRC Resume Request to the base station device 200-2 (S45).

When receiving the RRC Resume Request, the base station device 200-2 transmits a data request to the base station device 200-1 before the movement due to the cell reselection (S46). When receiving the data request, the base station device 200-1 causes a data response to include the ACK1 and transmits the data response to the base station device 200-2 (S47). Note that, since the base station device 200-1 has received Call Update after the transmission of the ACK1, the base station device 200-1 can recognize that the ACK1 has not reached the terminal device 100 (that there is a possibility that the ACK1 has not reached the terminal device 100).

The base station device 200-2 causes the DL-CCCH to include the ACK1, and transmits the DL-CCCH to the terminal device 100 (S48). The terminal device 100 receives the ACK1 (S48), and recognizes that the transmission of the uplink data 1 was successful.

The terminal device 100 causes the UL-CCCH to include subsequently generated uplink data 2, and transmits the UL-CCCH to the base station device 200-2 (S49). The base station device 200-2 causes the DL-CCCH to include the ACK2 indicating the reception of the uplink data 2, and transmits the DL-CCCH to the terminal device 100 (S50).

By extensively using a Cell Update procedure, the Cell Update method can perform the transmission/reception of the uplink and downlink small data without performing the paging with respect to all the base station devices in the RNA as performed in the first method.

### Cell Update

A description will be given of the Cell Update performed in the Cell Update method. For example, the Cell Update is defined as “cause =cell-Update” of “RRC Resume Request” which is transmitted by CCCH. Note that, in response to the RRC Resume Request, RRC Release subsequent thereto need not occur. The Cell Update is also defined as, e.g., “cause =cell-Update” of “UE Assistant Information” which is transmitted by DCCH.

### 1. Event Trigger

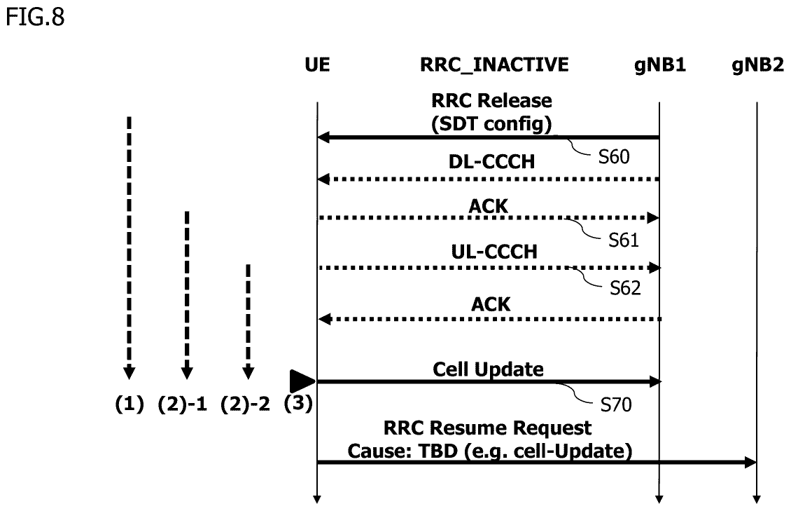

A description will be given of a transmission opportunity for the Cell Update. FIG. 8 is a diagram illustrating an example of the transmission opportunity for the Cell Update.

### 1.1 Transmission Opportunity 1 (Case (1))

A transmission opportunity 1 is timing at which SDT Failure Timer is expired. The terminal device 100 activates a timer when receiving the RRC Release (S60), and transmits the Cell Update at the time of expiration (S70). The terminal device 100 maintains the RRC_INACTIVE state (does not transfer to an RRC_IDLE state), and continuously performs the cell reselection.

### 1.2 Transmission Opportunity 2 (Cases (2)-1 and (2)-2)

A transmission opportunity 2 is timing at which a transmission failure (reaching of the number of retransmissions) in RLC (Radio Link Control) AM (Acknowledged Mode) is detected. The transmission opportunity 2 is also a transmission opportunity occurred when communication is performed in an AM mode.

In a case of downlink SDT, the terminal device 100 counts the number of transmissions of the corresponding ACK (S61), and transmits the Cell Update with timing of detecting that a predetermined number of transmissions are performed (S70).

In a case of the uplink SDT, the terminal device 100 counts the number of transmissions of the uplink data (S62), and transmits the Cell Update with timing of detecting that a predetermined number of transmissions are performed (S70). The terminal device 100 maintains the RRC_INACTIVE state (does not transfer to the RRC_IDLE state), and continuously performs the cell reselection.

### 1.3 Transmission Opportunity 3 (Case (3))

A transmission opportunity 3 is when Cell Reselection Criterion is satisfied. Requirements in the Cell Reselection Criterion comply with, e.g., TS38.304/TS38.133.

### 2. Transmission Condition

The terminal device 100 may also perform the cell reselection while a signal level in the serving cell is good such that the Cell Update reaches the connected cell (serving cell: the base station device 200 before the cell reselection).

For example, to particularly reduce a time required to camp-on (movement due to the cell selection) to low priority, the base station device 200 introduces a new threshold and notifies the terminal device 100 thereof by the RRC Release. Note that, when the terminal device 100 camps-on to High priority, it is not determined whether or not the signal level in the serving cell is low, and therefore a new threshold need not be configured.

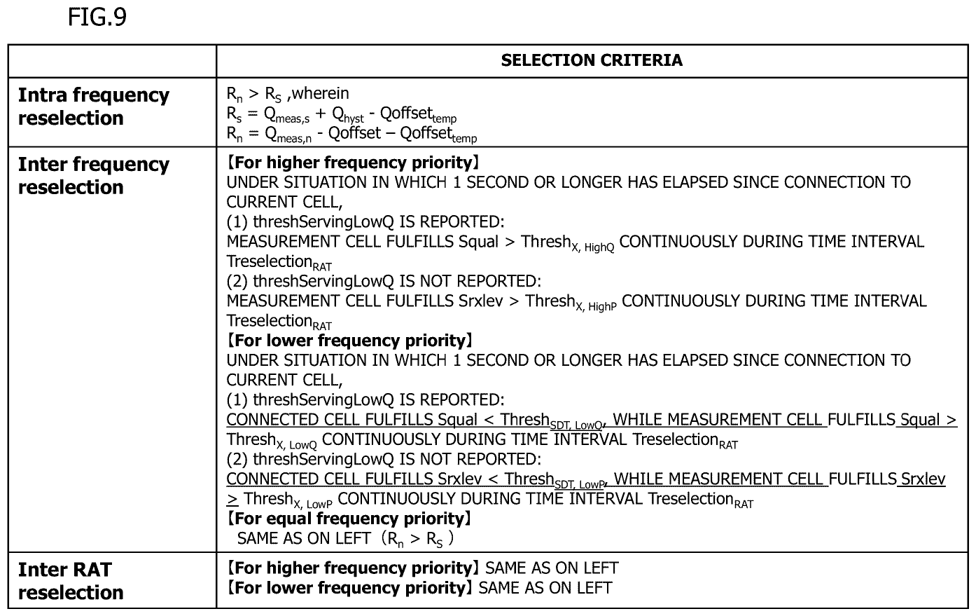

FIG. 9 is a diagram illustrating an example of selection criteria for selecting a new cell in the cell reselection. FIG. 9 illustrates an example of various cell reselections (Intra frequency reselection, Inter frequency reselection, and Inter RAT reselection). For (1) and (2) for camping-on to Low priority (For lower frequency priority) in the Inter frequency reselection in FIG. 9, respective underline conditions are provided. For (1) and (2), respective SDT wireless quality thresholds (Thresh_{SDT, LowQ}) and respective SDT reception level thresholds (Thresh_{sDT, LowP}) are newly defined. The SDT wireless quality thresholds are values higher (better) than wireless quality thresholds in normal cell reselection. Meanwhile, the SDT reception level thresholds are values higher than wireless quality thresholds in the normal cell reselection. This enables the terminal device 100 to perform the cell reselection while a radio wave condition in the connected cell is in a state better than in the normal cell reselection, and the Cell Update is easier to reach.

Note that, in FIG. 9, selection criteria in the Inter RAT reselection are confiured similarly to the selection criteria in the Inter frequency reselection.

### 3. SDT Failure Timer

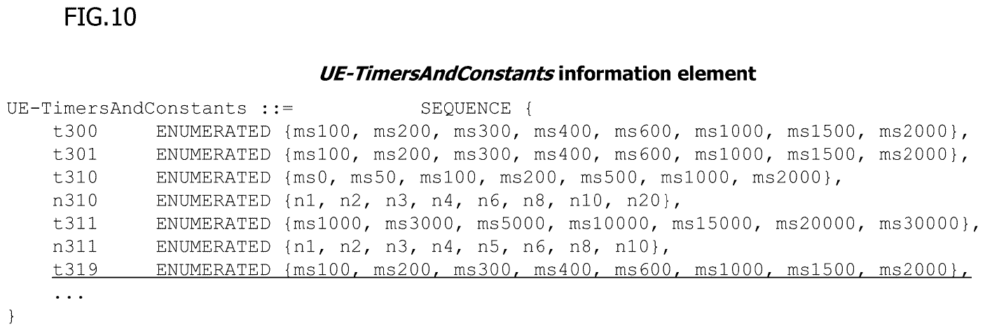

FIG. 10 is a diagram illustrating an example of a timer value of the SDT Failure Timer. When using the SDT Failure Timer as the transmission opportunity for the Cell Update, the terminal device 100 may also use, e.g., a value of T319. Alternatively, when using the SDT Failure Timer as the transmission opportunity for the Cell Update, the terminal device 100 may also use, e.g., a value set on the basis of the value (range) of T319 as a timer value.

### 4. RLC Maximum Number of Retransmissions

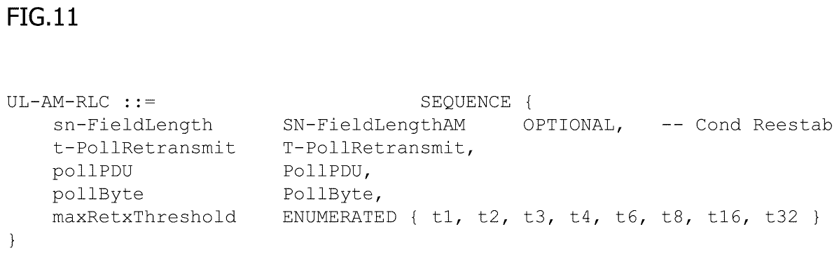

FIG. 11 is a diagram illustrating an example of an RLC maximum number of retransmissions. When using the RLC maximum number of retransmissions as the transmission opportunity for the Cell Update, the terminal device 100 may also use a conventional value of the RLC maximum number of retransmissions. When using the RLC maximum number of retransmissions as the transmission opportunity for the Cell Update, the terminal device 100 may also use a value set on the basis of the conventional value of the RLC maximum number of retransmissions as the RLC maximum number of retransmissions.

### 5. ASN.1

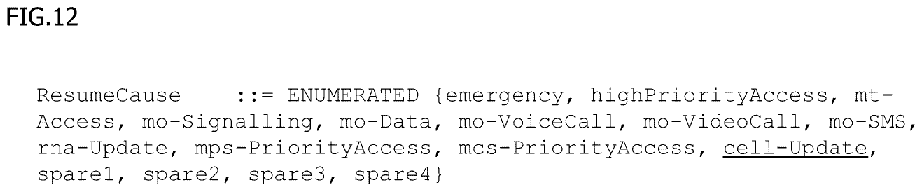

FIG. 12 is a diagram illustrating an example of ResumeCause. In FIG. 12, “cell-Update” is added to the ResumeCause. Note that, when a new Cause is added to the ResumeCause, not only the name “cell-Update”, but also, e.g., a name “cna-Update (Cell-based Notification Area Update)”, a name “sdt-Access”, or the like may also be used. As described previously, the ResumeCause can be transmitted by using the “RRC Resume Request” or “UE Assistant Information”.

### Third Embodiment

A description will be given of a third embodiment. In the third embodiment, a new RNA corresponding to the SDT is defined. Hereinbelow, the SDT RNA is referred to as, e.g., UE-specific RNA.

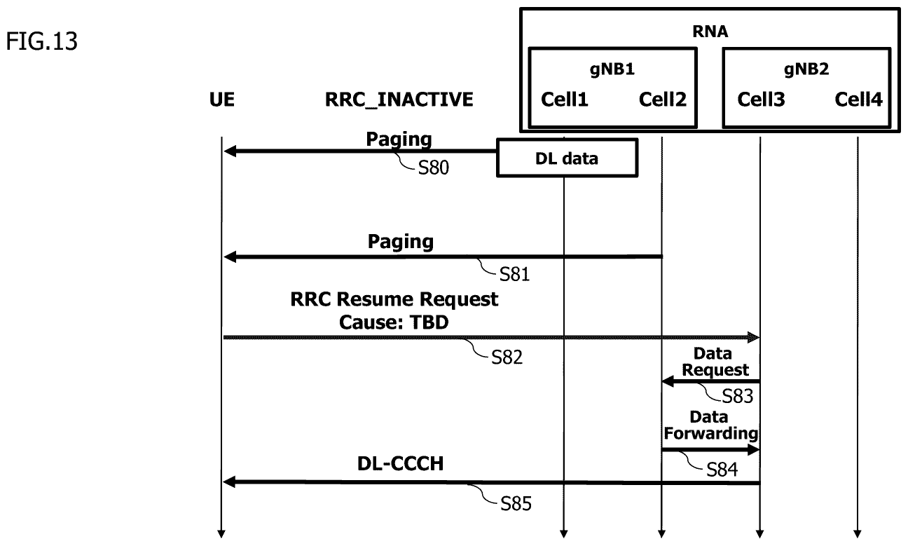

FIG. 13 is a diagram illustrating an example of a SDT sequence in the UE-specific RNA. In FIG. 13, the base station device 200-1 and the base station device 200-2 belong to the same RNA. In addition, each of the base station devices 200-1 and 200-2 is configured such that, e.g., the plurality of DUs and RUs are connected to the CU, and has a plurality of cells. The base station device 200-1 has Cell1 and Cell2, while the base station device 200-2 has Cell3 and Cell4. The UE-specific RNA is configured to include, e.g., a plurality of cells in the same base station device. In FIG. 13, the Cell1 and the Cell2 are included in one UE-specific RNA. It is assumed that, in FIG. 13, the terminal device 100 has performed the cell reselection from the Cell1 to the Cell3.

When downlink data is generated, the base station device 200-1 transmits paging for downlink data transmission (performing SDT) to the terminal device 100 in the RRC_INACTIVE state in the Cell1 and the Cell2 of the same UE-specific RNA (S80 and S81).

Since the paging other than the paging for performing SDT is transmitted in units of RNA, the paging is transmitted in the Cell1 to the Cell4. Meanwhile, in the present embodiment, the paging for performing SDT is transmitted in units of UE-specific RNA and accordingly, as illustrated in FIG. 13, the paging is transmitted in the Cell1 and the Cell2, while the paging is not transmitted in the Cell3 and the Cell4. This enables the wireless communication system 10 to reduce the transmission of the paging and reduce an amount of signal transmission in the entire system.

Due to the occurrence of mobility, the cell reselection has been performed to the Cell3, and therefore the terminal device 100 transmits the RRC Resume Request to the base station device 200-2 (Cell3) (S82). When receiving the RRC Resume Request, the base station device 200-2 transmits a data request to the base station device 200-1 before the movement due to the cell reselection (S83). When receiving the data request, the base station device 200-1 causes a response to include downlink data, and transmits the response to the base station device 200-2 (S84). The base station device 200-1 (Cell3) causes the DL-CCCH to include the downlink data, and transmits the DL-CCCH to the terminal device 100 (S85).

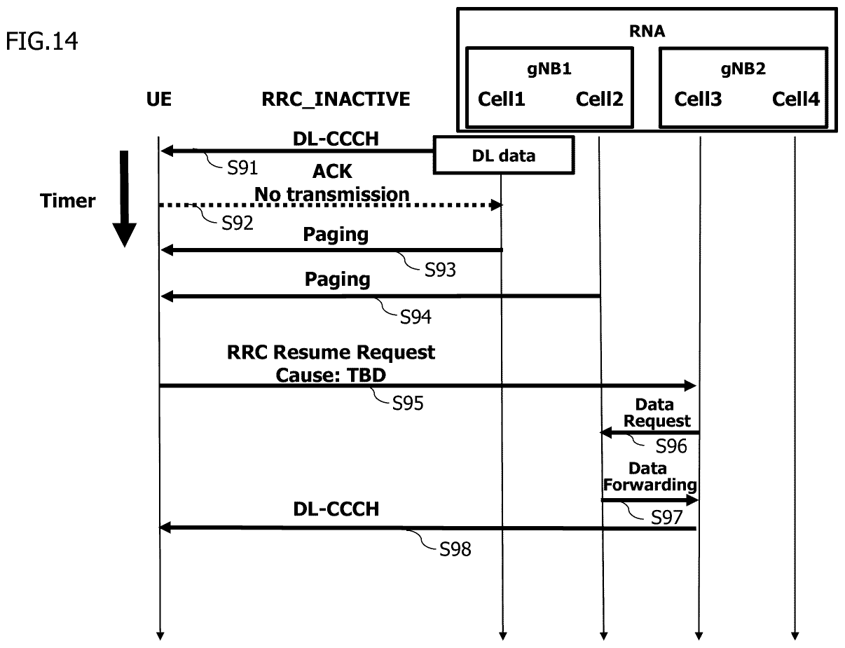

FIG. 14 is a diagram illustrating an example of the SDT sequence in the UE-specific RNA. In the example in FIG. 14, before the paging for performing SDT is performed, the downlink data is transmitted by using the DL-CCCH, and transmits the paging for performing the SDT when the ACK is not successfully received.

When the downlink data is generated, the base station device 200-1 causes the DL-CCCH to include the downlink data, and transmits the DL-CCCH to the terminal device 100 in the RRC_INACTIVE state (S91). Then, when the base station device 200-1 cannot receive the ACK for a predetermined period (when the base station device 200-1 cannot acknowledge reaching of data) (S92), the base station device 200-1 transmits the paging for the downlink data transmission (performing SDT) in the Cell1 and the Cell2 of the same UE-specific RNA (S93 and S94).

Thereafter, processing S95 to S98 is the same as processing S82 to S85 in FIG. 13. Note that, when successfully acquiring data upon reception of the DL-CCCH, the terminal device 100 may also transmit the ACK to the base station device 200-1. In this case, the paging for performing SDT is not transmitted, and accordingly it is possible to reduce the amount of signal transmission in the entire system.

### RRC Resume Request

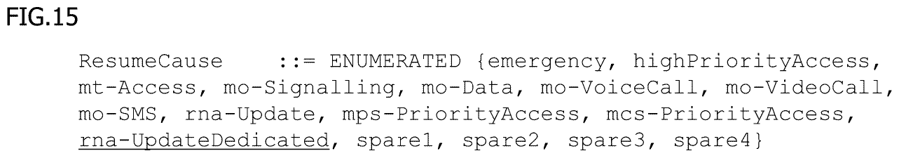

A description will be given of the RRC Resume Request in the UE-specific RNA. For the RRC Resume Request, a new Cause related to the UE-specific RNA may also be defined. FIG. 15 is a diagram illustrating an example of the ResumeCause. In FIG. 15, e.g., rna-UpdateDedicated (underlined portion) is newly added. Note that, when a new Cause is added to the ResumeCause, not only the name “rna-UpdateDedicated”, but also, e.g., a name “sna-Update (SDT-based Notification Area Update)”, a name “sna-UpdatDedicated”, or the like may also be used.

### Other Embodiments

The requirements described in the first to third embodiments and other embodiments may also be combined with each other. In addition, the requirements described in the first to third embodiments and the other embodiments may also be selectively used depending on, e.g., a wireless condition, system requirements, or the like.

Moreover, names such as the message and the channel in each of the embodiments are not limited to the names in examples. The message and the channel can be transmitted/received with timings and in states in the individual examples, and are not particularly limited to those used in the examples as long as necessary information can be included therein.

The disclosure enables transmission/reception of small data to be efficiently performed in cell reselection in an RRC_INACTIVE state.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A wireless communication apparatus comprising:
a communicator configured to perform a first type data communication which transmits and receives first type data with a counter wireless communication apparatus in a first mode; and
processor circuitry configured to control to perform the first type data communication by controlling to transmit, to the counter wireless communication apparatus in the first mode, a second paging for performing the first type data communication via a plurality of specific cells in an area which is formed by a plurality of cells, the area being transmitted a first paging, the second paging being different from a first paging.

2. The wireless communication apparatus according to claim 1,
the first mode is a state where the counter wireless communication apparatus is configured to receive the first-type data with predetermined timing, and
the first-type data is data smaller than a predetermined size.

3. The wireless communication apparatus according to claim 1, wherein the first mode is an RRC-INACTIVE state.

4. The wireless communication apparatus according to claim 1, wherein
the communicator is further configured to receive, from the counter wireless communication apparatus, a control signal after transmitting the second paging.

5. The wireless communication apparatus according to claim 4, wherein
the control signal is a RRC Resume Request.

6. The wireless communication apparatus according to claim 5, wherein
the RRC Resume Request includes ResumeCause indicating that first type data communication is to be performed in a RNA (RAN Notification Area) which includes the plurality of specific cells.

7. The wireless communication apparatus according to claim 5, wherein
the first paging is transmitted via the plurality of specific cells and a cell which is not included the plurality of specific cells.

8. The wireless communication apparatus according to claim 1, wherein
the first paging is RAN paging message.

9. The wireless communication apparatus according to claim 1, wherein
the area is an area which is configured to control to communication during the first mode.

10. A second wireless communication apparatus comprising:
a communicator configured to perform, in a first mode, a first type data communication which transmits and receives first type data with a counter wireless communication apparatus; and
processor circuitry configured to control to perform, in the first mode, the first type data communication by controlling to receive, from the counter wireless communication apparatus, a second paging for performing the first type data communication, the first paging is transmitted via a plurality of specific cells in an area which is formed by a plurality of cells, the area being transmitted a first paging, the second paging being different from a first paging.

11. The second wireless communication apparatus according to claim 10, wherein
the communicator is further configured to transmit, to the counter wireless communication apparatus, a control signal after receiving the second paging.

12. The second wireless communication apparatus according to claim 11, wherein
the control signal is a RRC Resume Request.

13. The second wireless communication apparatus according to claim 12, wherein
the RRC Resume Request includes ResumeCause indicating that first type data communication is to be performed in a RNA (RAN Notification Area) which includes the plurality of specific cells.

14. A wireless communication system comprising:
a first wireless communication; and
a second wireless communication configured to:
perform a first type data communication which transmits and receives first type data with the first wireless communication apparatus in a first mode, and
control to perform the first type data communication by controlling to transmit, to the counter wireless communication apparatus in the first mode, a second paging for performing the first type data communication via a plurality of specific cells in an area which is formed by a plurality of cells, the area being transmitted a first paging, the second paging being different from a first paging.
